(19) United States
(12) Patent Application Publication
(10) Pub. No.: US 2025/0065293 A1
(43) Pub. Date: Feb. 27, 2025

(54) ENERGY CONVERSION SYSTEM WITH A CONTINUOUS-FLOW METAL-WATER REACTOR

(71) Applicants: Siemens Energy Global GmbH & Co. KG, München (DE); The Royal Institution for the Advancement of Learning/McGill University, Montreal (CA)

(72) Inventors: George-Philippe Gauthier, Montreal (CA); Terrence Sullivan, Tega Cay, SC (US); Ryan Edmonds, Renton, WA (US); Michael Johnson, Montreal (CA); Gilles Bourque, Léry (CA); Jeffrey Myles Bergthorson, Montreal-West (CA); Jocelyn Blanchet, Saint-Polycarpe (CA); Keena Trowell, Montreal (CA)

(21) Appl. No.: 18/726,130

(22) PCT Filed: Jan. 13, 2022
(86) PCT No.: PCT/US2022/012233

§ 371 Date: Jul. 2, 2024

(51) Int. Cl. B01J 19/24; B01J 3/00; B01J 4/00

(52) U.S. Cl. CPC B01J 19/2415; B01J 3/008; B01J 4/002; B01J 2219/00094

(57) ABSTRACT

An energy conversion system includes a reactor vessel, a jacket disposed within the reactor vessel, the jacket having a wall that defines a chamber, a first end, and a second end opposite the first end, and a nozzle coupled to the reactor and arranged to direct a continuous flow of fuel at a flow rate into the chamber. The fuel including a mixture of a metal compound and water at a pressure that is greater than 221 bar. A cooling space is formed between the jacket and the reactor vessel and is operable to maintain a temperature of the fuel within the chamber between 374 and 800 degrees Celsius. A first gas outlet is in fluid communication with the chamber and is arranged to discharge a gas, and an outlet is in fluid communication with the chamber and is arranged to continuously discharge a reaction product and water.

### BACKGROUND

Hydrogen has the potential to replace fossil fuels in many applications. However, most of the hydrogen produced today comes from methane reformation, a process that relies on fossil fuels and releases greenhouse gases. Hydrogen can also be produced using electrolysis, a technique that uses an electric current to split a water molecule into its constituent hydrogen and oxygen. This process does not produce greenhouse gas emissions, but its cost can be prohibitive as it requires a large amount of electricity. Independently of its production method, hydrogen cannot be stored and transported easily due to its large specific volume, its significant leakage rates, and its inherent safety risks. Thus, an efficient source of hydrogen that does not produce greenhouse gases is desirable.

### SUMMARY

In one aspect, an energy conversion system includes a reactor vessel, a jacket disposed within the reactor vessel, the jacket having a wall that defines a chamber, a first end, and a second end opposite the first end, and a nozzle coupled to the reactor and arranged to direct a continuous flow of fuel at a flow rate into the chamber. The fuel including a mixture of a metal compound and water at a pressure that is greater than 221 bar. A cooling space is formed between the jacket and the reactor vessel and is operable to maintain a temperature of the fuel within the chamber between 374 and 800 degrees Celsius. A first gas outlet is in fluid communication with the chamber and is arranged to discharge a gas, and an outlet is in fluid communication with the chamber and is arranged to continuously discharge a reaction product and water.

In another aspect, an energy conversion system includes a reactor vessel, a jacket disposed within the reactor vessel, the jacket having a wall that defines a chamber, a first end, and a second end opposite the first end, and a nozzle coupled to the reactor and arranged to direct a continuous flow of fuel at a flow rate into the chamber, the fuel including a mixture of water and at least one of elemental aluminum, an aluminum alloy, and an aluminum compound at a pressure between 221 bar and 350 bar. A cooling space is formed between the jacket and the reactor vessel and is operable to maintain a temperature of the fuel within the chamber between 374 and 800 degrees Celsius. A first gas outlet is in fluid communication with the chamber and is arranged to discharge hydrogen, and an outlet is in fluid communication with the chamber and is arranged to continuously discharge an aluminum oxide and water.

In another construction, an energy conversion system includes a reactor having a nozzle for the receipt of a fuel at a flow rate, a gas outlet for the discharge of a flow of hydrogen, and an outlet for the discharge of a reaction product and water, the fuel including a mixture of a metal compound and water at a pressure that is greater than 221 bar. A cooling system includes an inlet to the reactor and an outlet from the reactor and a flow of coolant passes through the cooling system to maintain a temperature of the reactor between 374 and 800 degrees Celsius. A steam consumer is coupled to the flow of coolant and operable in response to a flow of steam generated by the flow of coolant and a hydrogen consumer is operable in response to the receipt of hydrogen from the reactor.

The foregoing has broadly outlined some of the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the Detailed Description below, it should be understood that various definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

To easily identify the discussion of any particular element or act, the most significant digit or digits in a reference number refer to the figure number in which that element is first introduced.

FIG. 1 is a perspective view of an energy conversion device in the form of a reactor.

FIG. 2 is a perspective view of a portion of a jacket of the reactor of FIG. 1.

FIG. 3 is a section view of the reactor of FIG. 1.

FIG. 4 is a schematic illustration of an energy conversion system that uses the byproducts of the reactor of FIG. 1

### DETAILED DESCRIPTION

Before any embodiments of the invention are explained in detail, it is to be understood that the invention is not limited in its application to the details of construction and the arrangement of components set forth in this description or illustrated in the following drawings. The invention is capable of other embodiments and of being practiced or of being carried out in various ways. Also, it is to be understood that the phraseology and terminology used herein is for the purpose of description and should not be regarded as limiting.

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

Also, it should be understood that the words or phrases used herein should be construed broadly, unless expressly limited in some examples. For example, the terms “including,” “having,” and “comprising,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Furthermore, while multiple embodiments or constructions may be described herein, any features, methods, steps, components, etc. described with regard to one embodiment are equally applicable to other embodiments absent a specific statement to the contrary.

Although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act may be termed a second element, information, function, or act, and, similarly, a second element, information, function, or act may be termed a first element, information, function, or act, without departing from the scope of the present disclosure.

In addition, the term “adjacent to” may mean that an element is relatively near to but not in contact with a further element or that the element is in contact with the further portion, unless the context clearly indicates otherwise. Further, the phrase “based on” is intended to mean “based, at least in part, on” unless explicitly stated otherwise. Terms “about” or “substantially” or like terms are intended to cover variations in a value that are within normal industry manufacturing tolerances for that dimension. If no industry standard is available, a variation of twenty percent would fall within the meaning of these terms unless otherwise stated.

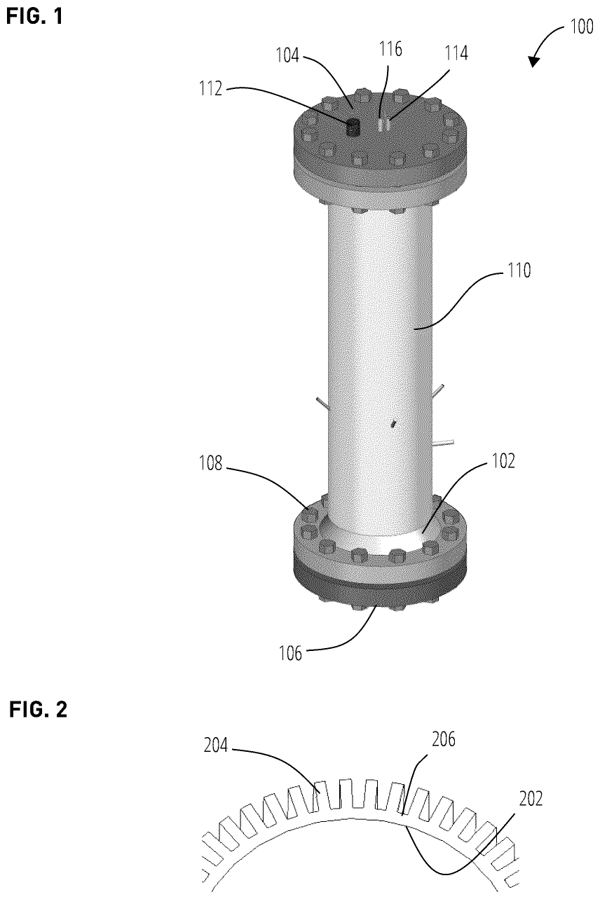

FIG. 1 illustrates a reactor 100 that includes a reactor vessel 102, a top cover 104, and a bottom cover 106. A number of bolts 108 are used to attach each of the top cover 104 and bottom cover 106 to the reactor vessel 102. Other constructions may employ other fasteners or other means of attaching the top cover 104 or the bottom cover 106 to the reactor vessel 102. One or more layers of insulation 110 may be wrapped around the reactor vessel 102.

As will be discussed in greater detail, the reactor 100 includes a coolant outlet 112, a gas outlet 114, and a nozzle 116 that each extend through the top cover 104. Of course, other constructions may position the gas outlet 114 and the nozzle 116 in other locations so that they do not pass through the top cover 104 but rather pass through an upper portion of the reactor vessel 102.

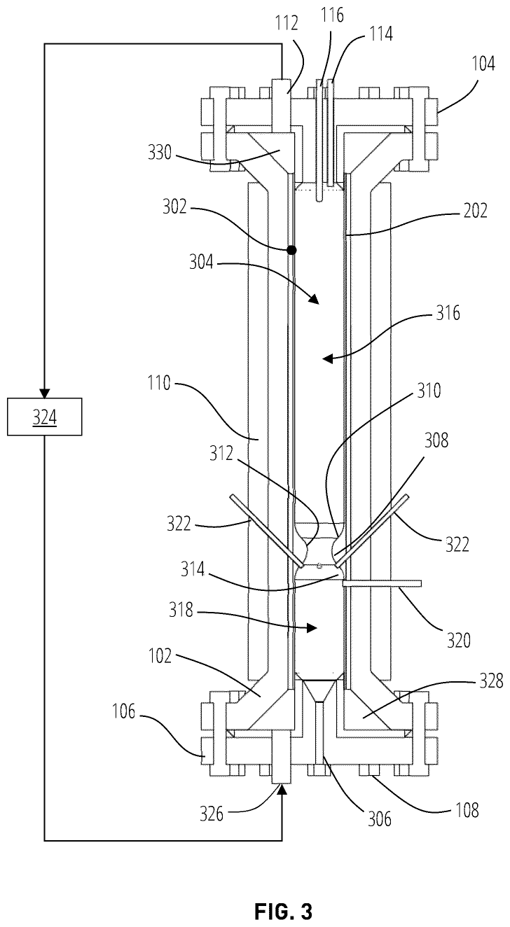

FIG. 3 is a section view of the reactor 100 of FIG. 1 which better illustrates the internal components. The reactor 100 includes a jacket 202 disposed within the reactor vessel 102. The jacket 202 may include one or more fins 204 (best illustrated in FIG. 2) that extend along the long axis of the jacket 202 and function to enhance the heat transfer efficiency of the jacket 202. The fins 204 are illustrated as having a rectangular cross section. However, any shape or arrangement could be employed for the fins 204 to enhance the heat transfer.

The jacket 202 cooperates with the reactor vessel 102 to define a cooling space 302 therebetween. In some constructions, the fins 204 are sized such that they do not contact the reactor vessel 102. In this arrangement a single continuous cooling space 302 is formed. In other constructions, some or all the fins 204 may contact an inner surface of the reactor vessel 102 such that the cooling space 302 includes multiple separated channels that extend along the length of the jacket 202.

Returning to FIG. 3, the jacket 202 includes an elongated wall that defines a chamber 304 and has a first end that receives the nozzle 116 and provides access for the gas outlet 114. A second end, opposite the first end provides access to a reaction product outlet 306 where reaction products are discharged from the chamber 304 defined by the jacket 202. In preferred arrangements, the jacket 202 and the reactor vessel 102 in which the jacket 202 is housed include elongated cylindrical portions that are arranged vertically with the first end above the second end. However, other arrangements and orientations may be possible.

To enhance operation, the jacket 202 may include a constriction 308 or narrow region of the inner surface. The outer surface of the jacket 202 may remain cylindrical such that the wall thickness near the constriction 308 is greater, or the wall thickness may be maintained with or without longer fins being employed.

In the illustrated construction, the constriction 308 includes a converging portion 310, a throat 312, and a diverging portion 314 such that it is shaped like a converging-diverging venturi with other shapes or arrangements being possible. The shape of the constriction 308 provides a local acceleration of the flow therethrough to hydrodynamically separate the components in the flow. The constriction 308 is positioned between 60 percent and 80 percent of the length of the jacket 202 with more preferred arrangements being between 65 percent and 75 percent. Thus, the constriction 308 divides the chamber 304 into an upper space 316 above the constriction 308 and a lower space 318 below the constriction 308.

In some constructions, a lower gas outlet 320 is provided below the constriction 308. As illustrated in FIG. 3, the lower gas outlet 320 is positioned in the uppermost portion of the lower space 318. However, other constructions may position the lower gas outlet 320 at a lower point within the lower space 318 or may position the lower gas outlet 320 in the constriction 308 below the throat 312 of the constriction 308.

The construction illustrated in FIG. 3 also includes one or more quench nozzles 322 positioned in the constriction 308. In the illustrated construction, the quench nozzles 322 are arranged such that they are normal to the inner surface of the diverging portion 314 of the constriction 308. Of course, other orientations are possible. In addition, while FIG. 3 illustrates two quench nozzles 322 and FIG. 1 illustrates three with a fourth hidden, arrangements with any number of quench nozzles 322 are possible.

The reaction product outlet 306 is positioned beneath the lower space 318 and includes a funnel shaped opening arranged to collect reaction products and discharge them from the chamber 304.

As will be discussed in greater detail, the reactor 100 is intended to perform an exothermic reaction such that some form of cooling will be used to maintain the reaction products within the chamber 304 in a desired temperature range. As illustrated in FIG. 3, a cooling system 324 provides a flow of coolant (e.g., water) to a coolant inlet 326. The coolant enters the reactor vessel 102 and is collected in a coolant inlet annulus 328. From the coolant inlet annulus 328 the coolant is distributed around the jacket 202 such that it is evenly distributed around the jacket 202 and the fins 204. The coolant flows upward through the cooling space 302 and is collected at a coolant outlet annulus 330 above the jacket 202. The fluid is discharged from the coolant outlet annulus 330 via the coolant outlet 112. It should be noted that while the coolant inlet 326 and the coolant outlet 112 are illustrated as passing through the bottom cover 106 and the top cover 104 respectively, other constructions may position the coolant inlet 326 and the coolant outlet 112 in other locations such as near the ends of the reactor vessel 102.

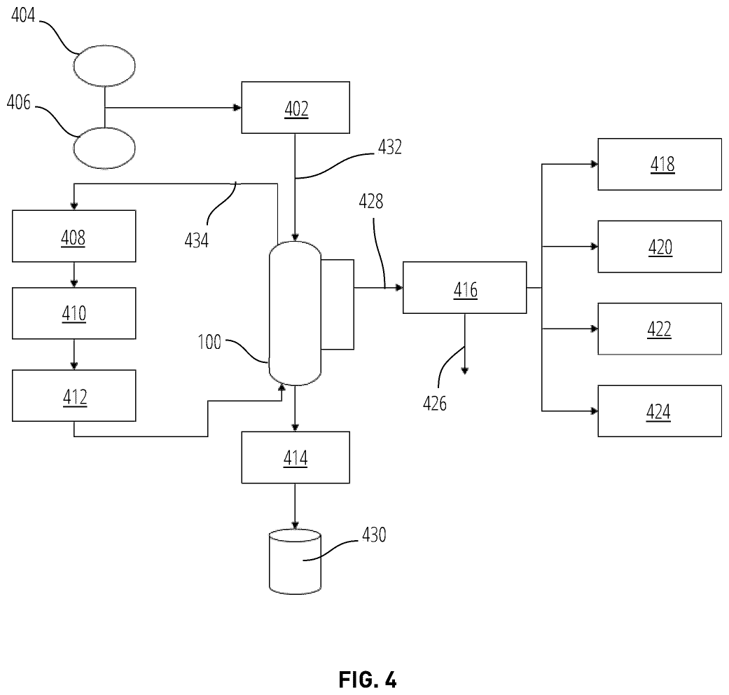

As will be discussed in greater detail with regard to FIG. 4, the cooling system 324 could include a simple system that includes a pump and a heat exchanger or could be a more complex system that uses the rejected heat to generate electrical power.

In operation, the reactor 100 receives a continuous flow of fuel via the nozzle 116. The term fuel as used herein includes a mixture of water and at least one of aluminum (Al), boron (B), magnesium (Mg), silicon (Si), titanium (Ti), manganese (Mn), zinc (Zn), and alloys or compounds thereof. The water in the mixture actually functions as an oxidizer while the metal or alloy is the fuel. As used herein with regard to the fuel, the term “alloys” should be read to include traditional alloys as well as oxides or other compounds that contain one of the elements suitable for use as the fuel.

The reactor 100 is intended to operate as a continuous-flow reactor 100. Thus, fuel is continuously added to the reactor 100 while reaction product and gas (e.g., hydrogen) are continuously removed from the reactor 100 via the reaction product outlet 306 and the gas outlet 114 respectively.

In addition, the reactor 100 is intended to be supercritical. To achieve this, the fuel is delivered at a pressure greater than 221 bar such as between 221 and 350 bar with a pressure of 300 bar being preferred. However, other reactors may operate in a sub-critical pressure range such as a pressure of 15.5 bar or more. In addition, the temperature within the chamber 304 is maintained between 374 and 800 degrees Celsius with a more preferred range being between 374 and 475 degrees Celsius. To be considered a supercritical reaction, the temperature must be maintained above 374 degrees Celsius. However, sub-critical reactors may operate in a temperature range from 200 to 800 degrees Celsius.

The following discussion will be specific to a process that uses aluminum as part of the fuel. However, as is clear, other fuels could be employed. Within the reactor 100, when using a fuel that contains aluminum, one of two reactions are expected depending upon the temperature within the chamber 304. Specifically, when operating between 374 degrees Celsius and 475 degrees Celsius, the reaction is expected to dominate. When the temperature within the chamber 304 is between 475 degrees Celsius and 600 degrees Celsius the reaction is expected to dominate.

The first reaction describes the conversion of aluminum and water into aluminum oxyhydroxide (AlOOH), and hydrogen. Aluminum oxyhydroxide can also be referred to as boehmite. As noted above, below 475 degrees Celsius, aluminum oxyhydroxide is the most stable product. However, above 475° C., aluminum oxide (Al2O3) is the most stable product. As discussed, both reactions are highly exothermic. The cooling system 324 operates to extract at least a portion of this energy to control the temperature of the chemical reaction within the chamber 304.

By operating the reactor 100 in a supercritical temperature and pressure range, the reactor 100 provides a full yield of the metal-water reaction (i.e., between 90% and 100% conversion) without the need for a catalyst or any additives. In addition, the process does not require disruption of the passivating layer of the metal, though a chemical agent or a mechanical manipulation. Further, the reactor 100 can use coarsely produced metal powders, chips, or scrap fragments, and metal particle sizes ranging from micron to centimeter scale.

The reactor 100, and specifically, the upper space 316 of the jacket 202 defines a supercritical reaction zone where the supercritical aluminum-water reactions described above take place. This zone is maintained at a pressure between 221 bar and 350 bar, and at a temperature between 374° C. and 800° C. The combination of these pressures and temperatures can be described as supercritical. These supercritical conditions are used to provide high reaction rates and complete reaction of the aluminum with water.

The lower space 318, disposed beneath the constriction 308 defines a high-pressure quench zone where pressure remains above 221 bar, but the temperature is reduced below 374° C. (sub-critical). Water injection via the quench nozzles 322 can reduce the temperature in the lower space 318. In addition, the cooling system 324 can be operated or arranged to provide additional cooling in this region (e.g., coolant inlet 326 near the bottom). Temperature and pressure conditions are chosen to provide for liquid phase water in the lower space 318.

The fuel is injected via the nozzle 116 as a slurry of aluminum particles and liquid water that is compressed to a pressure slightly above the pressure within the upper space 316. The slurry feed of fuel (e.g., aluminum and water) can be preheated using heat from the reactor 100, from the reactor outputs, or from the cooling system 324. This heat exchange can be direct or can involve an intermediate heat exchange loop of fluid.

The reaction products (e.g., H₂, AlOOH, and Al₂O₃) and excess water leave the reactor 100 through the gas outlet 114 (H₂), the lower gas outlet 320 (H₂), and the reaction product outlet 306 (reaction products, any solids, and water). The location of the gas outlet 114 and the lower gas outlet 320 are selected such that buoyancy, or gravitational separation, restrict heavier solid oxides (AlOOH and Al₂O₃) and liquid water (H₂O) from entry.

The heat produced by the reaction is removed from the chamber 304 by the jacket 202 and fins 204. In other arrangements, the jacket 202 includes one or more tubes wrapped around the jacket 202. In addition to facilitating cooling, the jacket 202 is formed from a corrosion-resistant material to protect the reactor vessel 102 from corrosion.

As discussed, the cooling system 324 typically includes water as a coolant. However, other coolants such as CO₂, molten salts, or organic fluids could be employed. When water is used, it is preferred that the water enter the reactor 100 as a liquid and exit as a saturated vapor or a superheated vapor. The direction of the coolant flow from the bottom of the reactor 100 to the top of the reactor 100 aids in managing heat transfer temperatures since the cooling fluid is at a lowest temperature when passing the lower-temperature lower space 318 and reaches its highest temperature when passing the higher-temperature upper space 316.

As discussed, the quench nozzles 322 are provided to cool the contents of the chamber 304. The quench nozzles 322 preferably inject liquid water to reduce the temperature in the lower space 318. This cools the oxide particles (AlOOH and Al₂O₃) for improved handling as they leave the reactor 100. This water injection also ensures any undesired chemical reaction is quenched by temperature reduction. Optionally, this water injection can be used to produce an AlOOH/Al₂O₃-water slurry that reduces erosion caused by oxide particles leaving the reactor 100.

The solid products of the reaction (i.e., oxide particles, AlOOH, Al₂O₃) collect by gravity at the bottom of the lower space 318 and leave the system as AlOOH or Al₂O₃ particles, or as a water-AlOOH/Al₂O₃ slurry via the reaction product outlet 306. The geometry of the reaction product outlet 306 may vary based on the downstream interface with auxiliary systems, which may include a lock-hopper and valves for pressure reduction of the reaction products. In some constructions, an additional liquid-water outlet port may be installed in the lower space 318. Excess liquid water could be sieved/filtered away from the slurry and evacuated separately by this port.

During steady-state operation, the reactor 100 allows for a self-sustaining continuous flow operation. Once the steady flow of incoming fuel is sprayed into the upper space 316, it is heated by the surrounding heat of reaction and starts reacting. The exothermic reaction is maintained at constant temperature by the cooling flow within the cooling space 302.

The size of the upper space 316 is selected to allow sufficient residence time (e.g., between 30 seconds and 70 minutes) for chemical conversion to be complete. The mixture flows downward through the upper space 316 until it passes the constriction 308 and the quench water that is injected via the quench nozzles 322. The quench water reduces the temperature of the reactants and products of reaction without significantly reducing the pressure. As the temperature drops in the lower space 318 some water may condense into a liquid state and collect at the bottom of the lower space 318 with the AlOOH and/or Al₂O₃ particles where they can be discharged via the reaction product outlet 306 as a liquid or slurry. The lighter gases (e.g., H₂ and steam) being more buoyant remain above the liquid water and oxide particles and can escape continuously through the lower gas outlet 320. These gaseous products being also lighter than the supercritical water and fuel mixture can also accumulate above the upper space 316 where they can escape through the gas outlet 114. To enhance buoyancy (gravitational separation) and reduce turbulence, long residence times and low flow velocities within the reactor 100 are preferred.

During start-up of the reactor 100, the necessary heat for the reaction is not present. As such, during start-up, the reactor 100 is initially operated in a batch mode. The reactor 100 is partially filled with fuel (e.g., mixture of aluminum and water) and the nozzle 116, the gas outlet 114, the lower gas outlet 320, the quench nozzles 322, and the reaction product outlet 306 are all closed. Once the reaction starts and the temperature and pressure within the reactor 100 increase towards the critical point, the gas outlet 114 and the lower gas outlet 320 open and enable steam/hydrogen to escape. Additional water may be injected to maintain the reaction during this phase.

Once the critical point of water is reached within the upper space 316, the batch mode continues to operate until the rate of hydrogen production starts to decrease. At this point, additional fuel (e.g., aluminum-water slurry) is injected through the nozzle 116 into the upper space 316 and the products of the reaction are removed from the lower space 318 through the reaction product outlet 306. The reactor 100 can then be switched to continuous operation, with continuous cooling flow from the cooling system 324 and quench water flow via the quench nozzles 322.

When the system is initially filled with aluminum and water, the initial onset of the reaction that leads to the thermal build-up needs to be enhanced. For this, various strategies can be used including adding aluminum oxyhydroxide (AlOOH) in the start-up mixture, using ultra-fine aluminum powder, adding external heat to the fuel or the reactor 100, or the use of catalysts or other additives.

While the reactor 100 is itself an energy conversion system that uses a chemical process to convert the chemical energy of the fuel into heat and a combustible gas, FIG. 4 illustrates some examples of other energy conversion systems that use the outputs or converted energy from the reactor 100 to provide energy in a desired form (e.g., electrical power, heat) for further use or conversion.

As discussed, the reactor 100 is capable of operating using a number of different fuels. However, the description of FIG. 4 will continue the example that uses aluminum as the fuel despite the reactor 100 of FIG. 4 being well-suited for use with many other fuels. Using this fuel, the reactor 100 produces heat and hydrogen as usable outputs.

With reference to FIG. 4, a supply of a metal 404 (e.g., aluminum, aluminum compounds, oxides, etc.) and a supply of water 406 is directed to devices that provide mixing and compression 402. The compression raises the pressure of the now mixed fuel 432 to the desired pressure level for the reactor 100. The fuel 432 passes through the reactor 100 as discussed with regard to FIG. 1 through FIG. 3 to produce heat, and more specifically, saturated or superheated steam 434, and hydrogen 428.

The steam 434 is directed to a steam turbine 408 where it operates to drive the steam turbine 408 and any component attached thereto. In most arrangements, an electrical generator is coupled to the steam turbine 408 such that the generator produces electrical power in response to the flow of steam 434. As discussed, the reactor 100 produces a significant amount of heat during the reaction. In one construction, a flow of 1 kg/s of aluminum fuel produces about 15.7 MW of heat energy which leads to enough steam 434 to generate about 3.9 MW of electricity via the steam turbine 408 and the generator. This results in a 25% steam-turbine-generator efficiency.

After the steam 434 passes through the steam turbine 408 the steam 434 is directed to a coolant condenser 410 where it is condensed to a liquid state. A pump 412 then pumps the water back to the reactor 100 to complete the cooling cycle.

The hydrogen 428 exits the reactor 100 as described and first passes through a condenser 416 where any water that may be mixed with the hydrogen 428 is separated to produce dry hydrogen. The dry hydrogen can be used in one or more of a number of different energy conversion devices. For example, the hydrogen could be combusted, either alone or as an additive to another fuel in a gas turbine 418, a reciprocating engine 420, or any other engine 422. The gas turbine 418, reciprocating engine 420, and/or other engine 422 could drive a generator that in turn generates electrical power (AC or DC) or current at a voltage as may be desired. In addition, the hydrogen 428 can be used in a fuel cell 424 to directly generate electrical power if desired. Of course, there are many other suitable uses for hydrogen (e.g., chemical processes, fertilizer manufacture, etc.) where the hydrogen could be used if desired.

The aluminum oxide products exiting the reactor 100 through a pressure reduction device 414, such as a lock-hopper, to be stored in a storage tank 430 at reduced pressure.

The system shown in FIG. 4 may include additional sub-systems to improve efficiency or reduce water consumption. For example, an expander can be used to extract work from the hydrogen 428 before it enters the condenser 416 or following passage through the condenser 416. For example, a heat exchanger can be used to extract heat from the product streams (either upstream of the pressure reducer 414 or upstream of the condenser 416, or in place of the condenser 416 as a combined recuperator and condenser) to preheat the incoming reactants (metal 404 and water 406) either upstream of the mixing and compression 402 or after the mixing and compression 402. For example, condensed water or condensate 426 from the condenser 416 or filtered water taken upstream of the pressure reducer 414, can be re-injected into the reactants before or after the mixing and compression 402.

The system illustrated herein is also capable of generating about 400 kg of hydrogen per hour in response to a flow of fuel that contains 1 kilograms of aluminum per second as an example.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

What is claimed is:

1. An energy conversion system comprising:
a reactor vessel;
a jacket disposed within the reactor vessel, the jacket having a wall that defines a chamber, a first end, and a second end opposite the first end;
a nozzle coupled to the reactor and arranged to direct a continuous flow of fuel at a flow rate into the chamber, the fuel including a mixture of a metal compound and water at a pressure that is greater than 221 bar;
a cooling space formed between the jacket and the reactor vessel and operable to maintain a temperature of the fuel within the chamber between 374 and 800 degrees Celsius;
a first gas outlet in fluid communication with the chamber and arranged to discharge a gas; and
an outlet in fluid communication with the chamber and arranged to continuously discharge a reaction product and water.

2. The energy conversion system of claim 1, wherein the wall includes an elongated cylindrical portion arranged vertically such that the first end is above the second end.

3. The energy conversion system of claim 1, wherein the reactor vessel includes a casing, a top cover coupled to a first end of the casing and a bottom cover coupled to a second end of the casing, the casing, the top cover, and the bottom cover cooperating to completely enclose the jacket.

4. The energy conversion system of claim 3, wherein the nozzle passes through the top cover and the outlet passes through the bottom cover.

5. The energy conversion system of claim 3, wherein the first gas outlet passes through the top cover.

6. The energy conversion system of claim 3, further comprising a coolant inlet that passes through the bottom cover and a coolant outlet that passes through the top cover, the coolant inlet, the cooling space, and the coolant outlet forming a cooling passage for the flow of a coolant.

7. The energy conversion system of claim 1, wherein the metal compound includes at least one of Al, B, Mg, Si, Ti, Mn, Zn, and alloys thereof and wherein the gas includes hydrogen.

8. The energy conversion system of claim 1, wherein the pressure within the chamber is between 221 and 350 bar.

9. The energy conversion system of claim 1, further comprising a constriction formed as part of the wall and positioned to divide the chamber into an upper space and a lower space.

10. The energy conversion system of claim 9, further comprising a second gas outlet positioned at a top of the lower space.

11. The energy conversion system of claim 1, wherein the jacket includes an outer surface, and wherein a plurality of fins extend from the outer surface into the cooling space.

12. An energy conversion system comprising:
a reactor vessel;
a jacket disposed within the reactor vessel, the jacket having a wall that defines a chamber, a first end, and a second end opposite the first end;
a nozzle coupled to the reactor and arranged to direct a continuous flow of fuel at a flow rate into the chamber, the fuel including a mixture of water and at least one of elemental aluminum, an aluminum alloy, and an aluminum compound at a pressure between 221 bar and 350 bar;
a cooling space formed between the jacket and the reactor vessel and operable to maintain a temperature of the fuel within the chamber between 374 and 800 degrees Celsius;
a first gas outlet in fluid communication with the chamber and arranged to discharge hydrogen; and
an outlet in fluid communication with the chamber and arranged to continuously discharge an aluminum oxide and water.

13. The energy conversion system of claim 12, wherein the wall includes an elongated cylindrical portion arranged vertically such that the first end is above the second end.

14. The energy conversion system of claim 12, wherein the reactor vessel includes a casing, a top cover coupled to a first end of the casing and a bottom cover coupled to a second end of the casing, the casing, the top cover, and the bottom cover cooperating to completely enclose the jacket.

15. The energy conversion system of claim 14, wherein the nozzle passes through the top cover and the outlet passes through the bottom cover.

16. The energy conversion system of claim 14, wherein the first gas outlet passes through the top cover.

17. The energy conversion system of claim 14, further comprising a coolant inlet that passes through the bottom cover and a coolant outlet that passes through the top cover, the coolant inlet, the cooling space, and the coolant outlet forming a cooling passage for the flow of a coolant.

18. The energy conversion system of claim 12, further comprising a constriction formed as part of the wall and positioned to divide the chamber into an upper space and a lower space.

19. The energy conversion system of claim 18, further comprising a second gas outlet positioned at a top of the lower space.

20. The energy conversion system of claim 12, wherein the jacket includes an outer surface, and wherein a plurality of fins extend from the outer surface into the cooling space.

21. An energy conversion system comprising:
a reactor having a nozzle for the receipt of a fuel at a flow rate, a gas outlet for the discharge of a flow of hydrogen, and an outlet for the discharge of a reaction product and water, the fuel including a mixture of a metal compound and water at a pressure that is greater than 221 bar;
a cooling system including an inlet to the reactor and an outlet from the reactor;
a flow of coolant that passes through the cooling system to maintain a temperature of the reactor between 374 and 800 degrees Celsius;
a steam consumer coupled to the flow of coolant and operable in response to a flow of steam generated by the flow of coolant; and
a hydrogen consumer operable in response to the receipt of hydrogen from the reactor.

22. The energy conversion system of claim 21, wherein the steam consumer includes a steam generator operable to produce a flow of steam from the flow of coolant, and a steam turbine operable in response to the flow of steam to power a generator to generate a first electrical power.

23. The energy conversion system of claim 21, wherein the hydrogen consumer includes one of a gas turbine, a reciprocating engine, and a fuel cell operable in response to the receipt of the flow of hydrogen to generate a second electrical power.

24. The energy conversion system of claim 21, wherein the reactor includes a reactor vessel, a jacket disposed within the reactor vessel, the jacket having a wall that defines a chamber, a first end, and a second end opposite the first end, and a cooling space formed between the jacket and the reactor vessel and operable to receive the flow of coolant.

25. The energy conversion system of claim 24, further comprising a constriction formed as part of the wall and positioned to divide the chamber into an upper space and a lower space.

26. The energy conversion system of claim 24, wherein the jacket includes an outer surface, and wherein a plurality of fins extend from the outer surface into the cooling space.
